(19) United States
(12) Patent Application Publication
(10) Pub. No.: US 2005/0102379 A1
(43) Pub. Date: May 12, 2005

(54) Method for on-line selecting and playing a media file

(75) Inventors: Chuan-Ching Su, Kaohsiung Hsien (TW); Chang-Hung Lee, Yuan Lin Hsien (TW); Mason Yen, Taipei (TW)

Correspondence Address: Ladas & Parry, 26 West 61st Street, New York, NY, 10023, US

(73) Assignee: BENQ CORPORATION

(21) Appl. No.: 10/983,397

(22) Filed: Nov. 8, 2004

(30) Foreign Application Priority Data
Nov. 11, 2003 (TW) 92131532

(51) Int. Cl. G06F 15/16

(52) U.S. Cl. 709/219; 709/231

(57) ABSTRACT

A method for on-line selecting and playing a media file that is stored in a server and a multimedia player is used for executing the media file and is further linked to the server via a network. The method comprising the steps of: (a) transmitting a request signal by the multimedia player to the server via the network for a selected list; (b) outputting the selected list to the multimedia player by the server upon receipt of the request signal; (c) formatting and inserting the selected list into a video signal and the multimedia player outputting the inserted video signal for displaying; (d) choosing an item from the selected list and subsequently transmitting the chosen item to the server; (e) transmitting a media file corresponding to the chosen item to the multimedia player; and (f) executing the media file by the multimedia player.

### FIELD OF THE INVENTION

The present invention relates to a method for on-line selecting and playing a media file, more particularly to a method for on-line selecting a media file stored in a server and playing or storing the media file in/on a multimedia player.

### BACKGROUND OF THE INVENTION

A media file is a digital data file which is composed of images, sound and words and which generally includes information too large, and is compressed into MPEG2 or MPEG4 format. The media files are stored within a compact disk, such a DVD (digital versatile disk) in compressed state since the DVD can contain a large data storage capacity. When it is desired to play and/or display the contents of the DVD on the display panel or over the audio system, a multimedia player must decompress and decode the media file representing the respective content. The display or play action follows later.

Presently, the playing range of a DVD player is limited to a specific area or locality, such as within a room. In the case, when the user runs out of the DVD, i.e., he has seen all of the available disks in his house, he is to buy or borrow the new ones. Borrowing or purchasing the new disk is inconvenient since the user must go outside his dwelling house.

Prevalence of network enables a user to browse the media file on-line is very common these days. The multimedia player can be a personal computer that permits the user to browse is provided with a in-built browser so that the user can enter into a server via the browser for browsing a web page or select a media file, download the selected media file under the RTP (real-time transport protocol) or HTTP (Hyper text transfer protocol) or TCG (transmission control protocol) or GUI (graphics user interface). The selected media file is later displayed over the display panel or the audio system by streaming technique in image and sound effects. The aforesaid communication protocols are only suitable for transmitting texts or web pages, and are not suitable for audio-and-video data transmission. The image often gets lost during the stream data transmission. In addition, insufficient bandwidth of the network or slow data transmission may adversely affect the sharpness, crispness and fine pixel of the images.

Alternatively, there is a terminal/server architecture used by the user to login into the server via a network interface so as to download a media file with the assistance of a remote data processor or under the graphics user interface protocol. The downloaded media file is displayed over the display panel later by means of streaming. This and the aforesaid protocols suffer from insufficient transmission rate and may result in intermittent interruption of images on the display panel. As a matter of fact, the server is adapted to control the transmission rate of the media file so that when a plurality of terminals are connected to the server, the porting work carried by the ROT (Real-time Operation system) of the server is accordingly increased or overload, which, in turn, may result in communication interruption between the respective terminal and the server or jamming action of the respective terminal.

It is the object of the present invention is to find a resolution to remedy the aforesaid disadvantages.

### SUMMARY OF THE INVENTION

The object of the present invention is to provide a method for on-line selecting and playing a media file by the multimedia player.

In one aspect of the invention, a method is proposed to select and play a media file on-line, wherein the media file is stored in a server and a multimedia player is used for executing the media file and is further linked to the server via a network. The method for on-line selecting and playing the medial file comprising the steps of: (a) transmitting a request signal by the multimedia player to the server via the internet for a selected list; (b) outputting the selected list to the multimedia player by the server upon receipt of the request signal; (c) formatting and inserting the selected list into a video signal and the multimedia player outputting the inserted video signal for displaying; (d) choosing an item from the selected list and subsequently transmitting the chosen item to the server; (e) transmitting a media file corresponding to the chosen item by the server to the multimedia player; and (f) executing the media file by the multimedia player.

In a second aspect of the present invention, a method for on-line playing a media file is proposed, wherein the media file is stored in a first server and a second server is used for managing the media file, a multimedia player is used for playing the media file, and is further linked to the first server via the peer-to-peer protocol. The method for on-line playing the medial file comprising the steps of: (a) transmitting a request signal by the multimedia player to the second server for a selected list; (b) outputting the selected list by the second server to the multimedia player upon receipt of the request signal; (c) formatting and inserting the selected list into a video signal, the multimedia player outputting the inserted video signal for displaying (d) choosing an item from the selected list and subsequently transmitting the chosen item to the first server; (e) transmitting a media file corresponding to the chosen item by the first server to the multimedia player; and (f) executing the media file by the multimedia player.

In a third aspect of the invention, a multimedia player is proposed and is adapted to be linked to a server via a network, the server including a plurality of media files and a selected list corresponding to a set of media files, the multimedia player connecting a display for playing each of the media files and comprising: (a) a first terminal for connecting to the server via the network; (b) a control unit linked to the first terminal, the control unit transmitting a request signal to the server, the server responding and transmitting the selected list to the control unit; (c) a second terminal for connecting to the display; (d) a data processor linked to the control unit for outputting a video signal to the display via the second terminal, wherein the selected list is displayed on the display; and (e) a responding unit connected to the control unit, and transmitting a selected signal, the server transmitting the media file to the multimedia player according to the selected signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a first preferred embodiment, illustrating how a multimedia player is linked a display panel and a server via the internet according to the method of the present invention;

FIG. 2 is a block diagram, illustrating the steps for on-line selecting and playing a media file according to the first preferred embodiment of the method of the present invention;

FIG. 3 shows a multimedia player constructed according to the method of the present invention;

FIG. 4 shows a selected list shown on a display panel of the multimedia player constructed according to the method of the present invention;

FIG. 5 is a second preferred embodiment, illustrating how a multimedia player is linked a display panel and servers via the internet according to the method of the present invention; and

FIG. 6 is a block diagram, illustrating the steps for on-line playing a media file according to the second preferred embodiment of the method of the present invention.

### DETAILED DESCRIPTION OF THE PREFERRED EMBODIMENTS

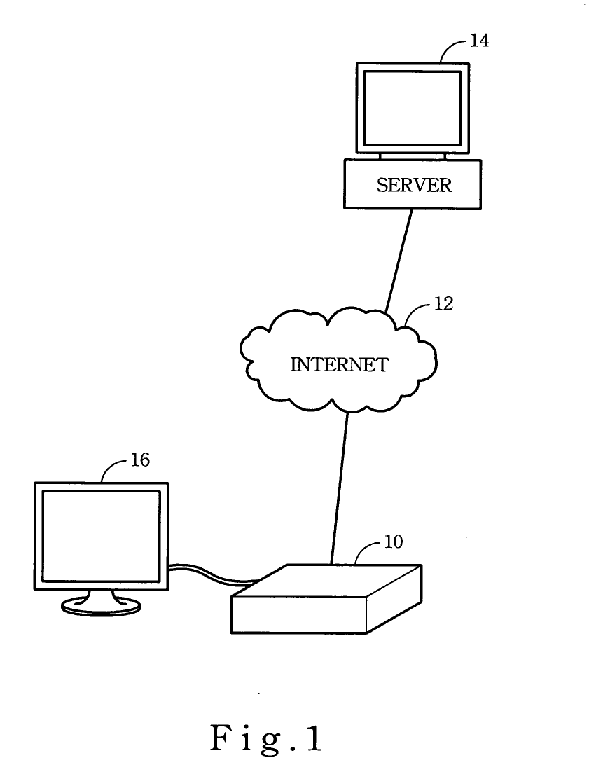

Referring to FIG. 1, a first preferred embodiment according to the present invention is shown to include a multimedia player 10, a server 14 and a network 12 (preferably the internet). The multimedia player 10 can be a video player, such as DVD player, that is provided with an optical device for reading/displaying a media file over a display 16 (such as a TV set or monitor). The media file is generally written in MPEG4 or MNPEG2 format in compressed state. The multimedia player 10 can be provided an in-built video or audio recorder or connected to an externally disposed video or audio recorder so the media file transmitted from the server 14 can be recorded or reproduced. The server 14 is stored with a plurality of media files, and is linked to the multimedia player 10 via the network 12. The network 12 can be an Ethernet or an intranet or VPN (Virtual Page Number) internet protocol. The multimedia player 10 and the server 14 is linked under the peer-to-peer protocol so as to share information therebetween.

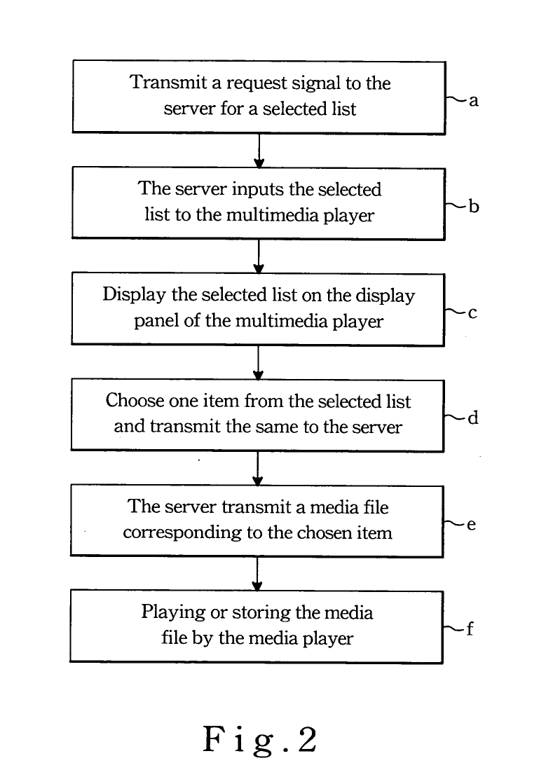

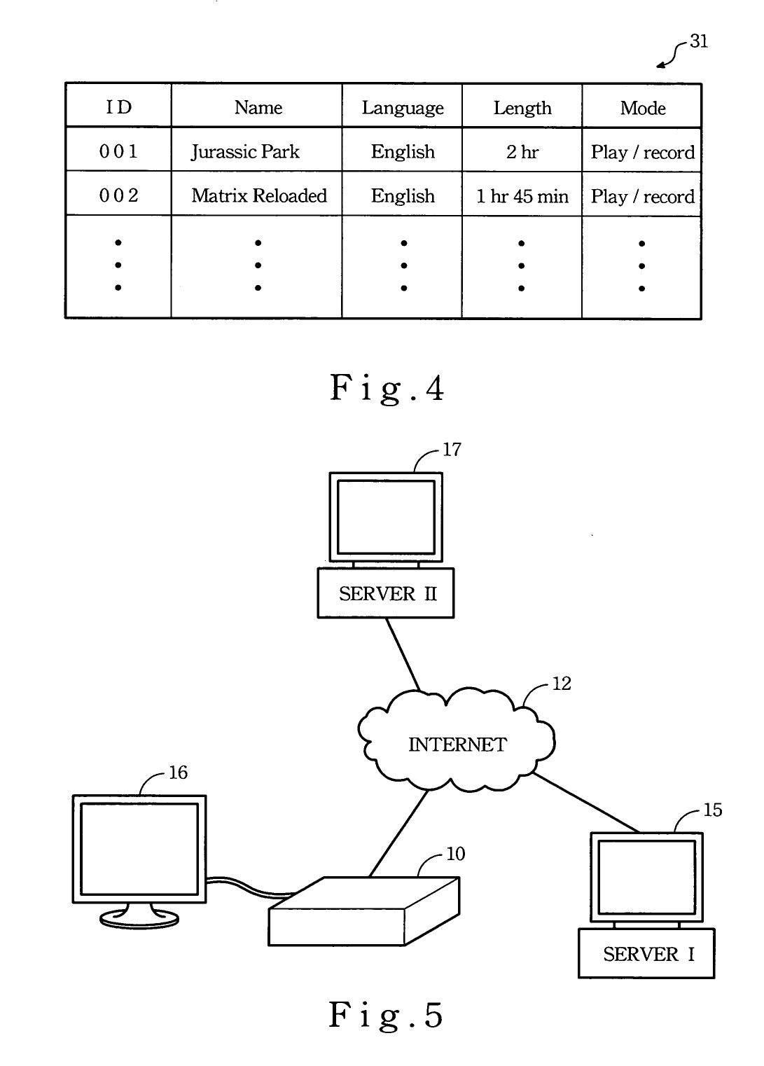

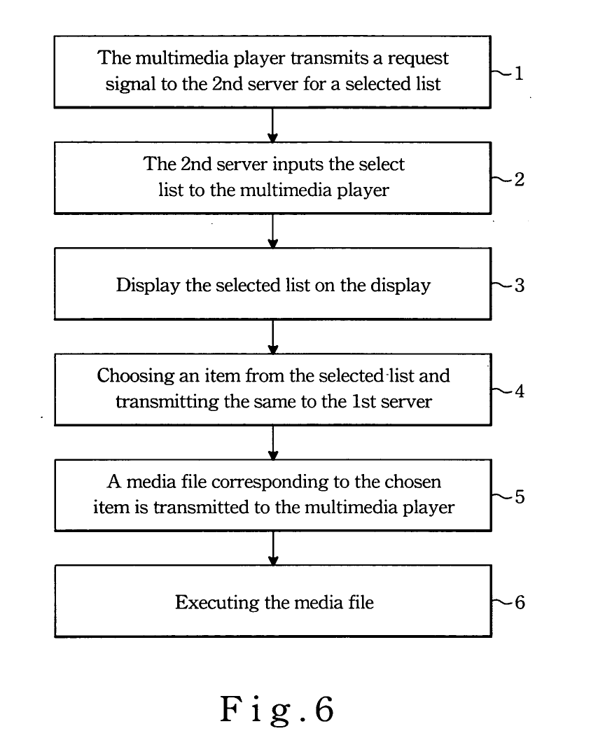

FIG. 2 shows the steps of on-line selecting and playing the media file according to the present invention. According to step (a), a request signal is sent by the multimedia player 10 to the server 14 via the internet 12 for a selected list 31 (see FIG. 4). Step (b) the server 14 inputs the selected list 31 into the multimedia player 10 upon receipt of the request signal, wherein the selected list 31 includes a plurality of items (001, 002 . . . ), each of which presents a respective file name (Jurassic Park, Matrix Reloaded, . . . ). Step (c) the selected list 31 will be displayed on the display 16 in OSD (On Screen Display) mode such that the selected list 31 comes into view upon pressing of a menu switch on the display 16. Alternatively, the selected list 31 can be stored within the multimedia player 10 since the latter is provided with a built-in storage unit 102. Step (d) the user can choose an item from the selected list 31 and transmits the chosen item is to the server 14. Step (e) a media file corresponding to the chosen item is transmitted by the server 14 to the multimedia player 10. Step (f) the media file is executed by the multimedia player 10.

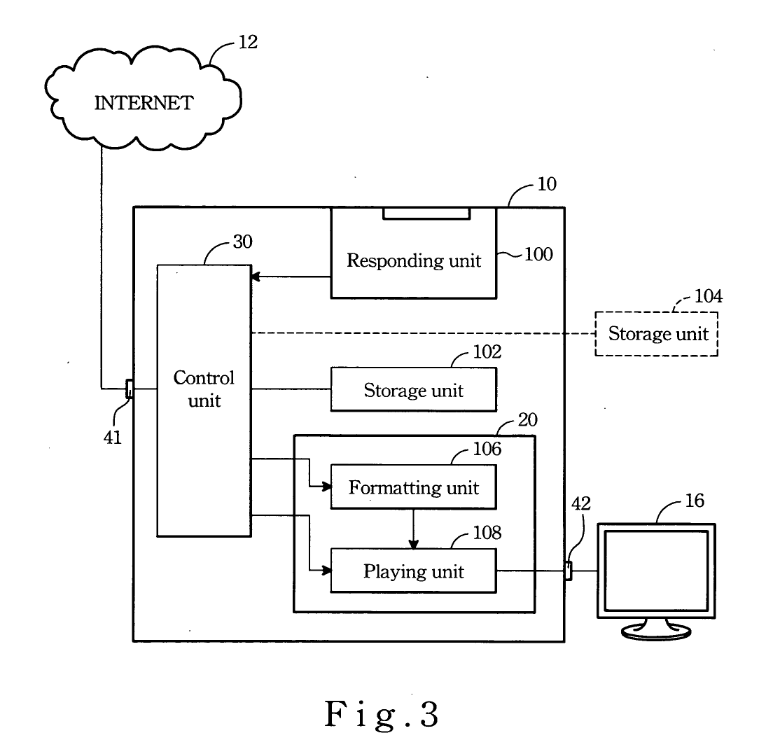

As illustrated in FIG. 3, the multimedia player 10 has a first terminal 41, a second terminal 42, a control unit 30, a data processor 20, and a responding unit 100. The first terminal 41 is linked to the server 14 via the internet 12. The control unit 30 is linked the server 14 via the first terminal 41, can transmit the request signal to the server 14 for the selected list 31 when a signal communication is established between the control unit 30 and the server 14 under an ad-hoc mode to permit conduction of a wireless data transmission therebetween such that the server 14 outputs the selected list 31 upon receipt of the request signal. The second terminal 42 is linked to the display 6. The data processor 20 is linked to the control unit 30. The responding unit 100 is linked to the control unit 30, is capable of transmitting the chosen item from the selected list to the server 14 such that the server 14 transmits the media file corresponding to the chosen item back the multimedia player 10, where the data processor 20 executes the media file into an image file so that the image file can be sent from the second terminal 42 to the display 16. The image file is accordingly displayed over the display 16.

Preferably, the data processor 20 includes a formatting unit 106, an playing unit 108, and an external storage unit 104. The external storage 104 is linked to the control unit 30 which is capable of sending a control command corresponding to the respective media file to the formatting unit 106, wherein the selected list 31 includes the control command, which may be a play or store instruction. The formatting unit 106 is adapted to convert the media file into a MPEG format and sending the formatted selected list to the playing unit for inserting into the video signal. So the video signal can be played out on the display 16 with the selected list. In addition, the media file can be simultaneously stored or recorded within the storage unit 102 or 104 while the same is being played or displayed on the display 16 or over the playing unit 108.

As shown in FIG. 4, the selected list 31 is a HTML text that includes a plurality of the items ID (001,002, . . . ), file names (Jurassic Park, Matrix Reloaded), length of the files, language version, actor names, and control signals, and etc . . . Each of the items ID in the selected list 31 is linked to a respective media file via the hyperlink protocol. Thus, when one of the items ID is chosen, the media file corresponding to the chosen item will be displayed on the display 16 by means of stream data transmission. The item choosing action can be conducted by pointing a respective remote control to the selected list 31.

In this preferred embodiment, the multimedia player 10 is linked to the server 14 in ad-hoc mode via the WLAN IEEE 802.11 so as to permit conduction of a wireless data transmission therebetween. The multimedia player 10 can be linked to the server 14 via the Ethernet Protocol or a specific IP (Internet Protocol) so as to increase the data transmission rate and so as to provide fine pixel of the images. In addition, the communication interrupt between the server 14 and the multimedia player 10 or the jamming of the multimedia player 10 can be avoided because the porting-work carried out by the RTOS (Real-Time Operation System) of the server 14 is not overloaded regardless of downloading amount by a plurality the multimedia players 10.

Referring to FIG. 5, a second preferred embodiment of the present invention is shown to include a first sever 15, a second server 17, a display 16, and a multimedia player 10. A plurality of media files are stored within the first server 15, wherein each of the media file is written MPEG 2 or 4 format. The second server 17 is used for executing the media file. The multimedia player 10 is used for playing the media file and is further linked the second server 17 under the peer-to-peer protocol so as to share information therebetween. The method for on-line playing the media file according to the present invention includes the following steps. Step (1) the multimedia player 10 transmits a request signal the second server 17 for a selected list. Step (2) upon receipt of the request signal, the second server 17 inputs the selected list 31 to the multimedia player 10, wherein the selected list 31 includes a plurality of items (001, 002 . . . ), each of which represents a respective file name (Jurassic Park, Matrix Reloaded, . . . ).Step (3) the selected list 31 will be displayed on the display 16 in OSD (On Screen Display) mode. Step (4) choosing an item ID from the selected list 31 and subsequently transmitting the chosen item ID to the first server 15. Step (5) transmitting a media file corresponding to the chosen item ID by the first server 15 to the multimedia player 10. Step (6) executing the media file by the multimedia player 10. The executing operation in step (6) can be a displaying or playing action such that a movie can be displayed on the display 16 or the playing unit installed within the multimedia player 10 can play a song. The first and second servers 15,17 are in signal communication with each other via the network 12, which can be Ethernet protocol or a specific IP (Internet Protocol) so as to increase the data transmission rate and so as to provide fine pixel of the images.

Note that the selection or storing action is performed on the multimedia player 10 so as to facilitate the user while the transmission rate of the media file is controlled by the servers. From the above description, it is observed that there is no communication interruption between the respective server or jamming action of the multimedia player 10.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A method for selecting and playing a media file on-line, the media file being stored in a server, a multimedia player being used for executing the media file, the multimedia player being connected to the server via a network, the method for selecting and playing the media file on-line comprising the steps of:
(a) transmitting a request signal by the multimedia player to the server via the network for a selected list;
(b) outputting the selected list to the multimedia player by the server upon receipt of the request signal;
(c) formatting and inserting the selected list into a video signal and the multimedia player outputting the inserted video signal for displaying;
(d) choosing an item from the selected list and subsequently transmitting the chosen item to the server;
(e) transmitting the media file corresponding to the chosen item by the server to the multimedia player; and
(f) executing the media file by the multimedia player.

2. The method according to claim 1, wherein the network is a wireless network, wherein the multimedia player and the server are linked under ad-hoc mode to permit conduction of a wireless data transmission therebetween.

3. The method according to claim 1, wherein the media file stored in the server is in MPEG format, the multimedia player being adapted to play the media file in MPEG format.

4. The method according to claim 1, wherein in the step (f) the executing operation is to play the media file.

5. The method according to claim 1, wherein in the step (f) the executing operation is to store the media file.

6. The method according to claim 1, wherein the multimedia player further includes a display, the selected list being displayed on the display in OSD (On Screen Display).

7. The method according to claim 1, wherein each of the items in the selected list is a HTML (Hypertext Markup Language) text, each of the items in the selected list being linked to a respective media file via the hyperlink protocol.

8. The method according to claim 1, wherein the media file is transmitted to the multimedia player from the server by means of streaming.

9. The method according to claim 1, wherein the selected list includes a series of number respectively representing the media files of the server.

10. The method according to claim 9, wherein the selected list includes a plurality of control signals for controlling the media files included in the selected list.

11. The method according to claim 10, wherein the control signals include play and store commands.

12. A method for playing a media file on-line, wherein the media file is stored in a first server and a second server is used for managing the media file, a multimedia player being used for playing the media file, and is further linked to the second server via the peer-to-peer protocol, the method for on-line playing the media file comprising the steps of:
(a) transmitting a request signal by the multimedia player to the second server for a selected list;
(b) outputting the selected list by the second server to the multimedia player upon receipt of the request signal;
(c) formatting and inserting the selected list into a video signal, the multimedia player outputting the inserted video signal for displaying;
(d) choosing an item from the selected list and subsequently transmitting the chosen item to the first server;
(e) transmitting the media file corresponding to the chosen item by the first server to the multimedia player; and
(f) playing the media file by the multimedia player.

13. The method according to claim 12, wherein the multimedia player and the first server is linked under ad-hoc mode to permit conduction of a wireless data transmission therebetween

14. The method according to claim 12, wherein the media file stored in the first server is in MPEG format, the multimedia player being adapted to play the media file in MPEG format.

15. The method according to claim 12, wherein in the step (f) executing operation is to play the media file on the display.

16. The method according to claim 12, wherein in the step (f) the executing operation is to store the media file.

17. The method according to claim 12, wherein the multimedia player further includes a display, the selected list being displayed on the display of the multimedia player in OSD (On Screen Display).

18. The method according to claim 12, wherein each of the media files in the selected list is a HTML (Hypertext Markup Language) text, each of the items in the selected list being linked to a respective media file via the hyperlink protocol.

19. The method according to claim 12, wherein the e media file is transmitted to the multimedia player from the first server by means of streaming.

20. A multimedia player for connecting to a server via a network, the server including a plurality of media files and a selected list corresponding to the media files, the multimedia player playing the media files via a display, the multimedia player comprising:
a first terminal for connecting to the server via the network;
a control unit linking to the first terminal, the control unit transmitting a request signal to the server, the server responding and transmitting the selected list to the control unit;
a second terminal for connecting to the display;
a data processor linked to the control unit for outputting a video signal to the display via the second terminal, wherein the selected list is displayed on the display; and
a responding unit connected to the control unit, and transmitting a selected signal according to the selected list, the server transmitting the media file to the multimedia player according to the selected signal.

21. The multimedia player according to claim 20, wherein the data processor further comprises:
a formatting unit; and
a playing unit for outputting the video signal;
wherein upon receipt of the selected list, the formatting unit formatting the selected list in a predetermined format and sending to the playing unit, the playing unit inserting the formatted selected list into the video signal.

22. The multimedia player according to claim 21, wherein the control unit further sends a command to the formatting unit , the command being saving or play the media file.

23. The multimedia player according to claim 20 further comprising a storage unit for storing a plurality of media files.
